(19) United States
(12) Patent Application Publication
(10) Pub. No.: US 2023/0067824 A1
(43) Pub. Date: Mar. 2, 2023

(54) PREFERENCE INFERENCE DEVICE, PREFERENCE INFERENCE METHOD, AND PREFERENCE INFERENCE PROGRAM

(71) Applicant: NEC Corporation, Minato-ku, Tokyo (JP)

(72) Inventor: Koji ICHIKAWA, Tokyo (JP)

(73) Assignee: NEC Corporation, Minato-ku, Tokyo (JP)

(21) Appl. No.: 17/800,153

(22) PCT Filed: Mar. 6, 2020
(86) PCT No.: PCT/JP2020/009816

§ 371 Date: Aug. 16, 2022

(51) Int. Cl. G06Q 30/06; G06Q 30/02

(52) U.S. Cl. CPC G06Q 30/0631; G06Q 30/0201

(57) ABSTRACT

The preference inference device 80 includes a preference inference means 81. The preference inference means 81 infers, based on a conversion rule that approximates a first preference distribution for items in a first domain indicated by a first user set to a second preference distribution for items in a second domain indicated by a second user set, a preference in the second domain for a user in the first user set.

### TECHNICAL FIELD

This invention relates to a preference inference device, a preference inference method, and a preference inference program for inferring user preferences.

### BACKGROUND ART

Many companies have a strong need to drive active users from one service to another. For example, large electronic commerce companies often offer multiple services, such as movie and music streaming, e-books, and insurance, and so on. At this time, for example, there are many users who are active in music streaming services but indifferent to e-books and insurance with no activity in these domains. However, it is not easy to make individual recommendations to such users for products in inactive domains.

In addition to large e-commerce companies, small and medium-sized e-commerce companies may also have websites that sell products. Since many users only purchase products in specific categories (e.g., beverages and food) on such sites, there is a need to recommend products in other categories.

Furthermore, from the perspective of managing a department store or shopping mall, the challenge is how to direct users to stores in many different domains. From the manufacturer's perspective, there is a need to direct users of one brand (e.g., moisturizing cosmetics) to another brand (e.g., restful sleep goods).

In light of these needs, methods are proposed to recommend products in one domain to users in the other domain between two domains with non-overlapping users or products. For example, Non-Patent Literature 1 describes a method for making recommendations between domains of unshared users or products. The method described in Non-Patent Literature 1 assumes that the user characteristics of the two domains are generated from a same multivariate Gaussian probability distribution, and the distribution is learned to explain the two sets of actual data simultaneously.

### CITATION LIST

### Non Patent Literature

NPL 1: Iwata, Takeuchi, “Cross-domain recommendation without shared users or items by sharing latent vector distributions”, Proceedings of the 18th International Conference on AISTATS 2015, JMLR: W&CP vol. 38, pp. 379-387, 2015

### SUMMARY OF INVENTION

### Technical Problem

In general, with the technology of making individual recommendations across multiple domains, it is assumed that a certain number of users overlap the two domains and that their identifiers are tied to each other. Another situation is when there is a certain amount of information (e.g., occupation, income, gender, age, hobbies, etc.) about each user, and it is possible to compare user similarity between the two domains. However, there are not necessarily many cases where such a situation can be assumed. Therefore, it is difficult to say that individual recommendations can necessarily be made appropriately when domains with no overlap in users or products are assumed.

In addition, the method described in Non-Patent Literature 1 assumes a simple Gaussian distribution as the distribution of user characteristics, which may result in an oversimplification of complex user preference distributions and thus reduce the accuracy of recommendation.

Furthermore, the method described in Non-Patent Literature 1 requires fitting two sets of actual data at the same time, so the calculation order may be the order of the number of two sets of actual data, which may increase costs.

Therefore, it is desirable to be able to infer preferences in other domains regarding users in one domain, even between two domains that do not overlap in users or items, while limiting such cost increases.

Therefore, it is an exemplary object of the present invention to provide a preference inference device, a preference inference method, and a preference inference program that can infer preferences in the other domain regarding users in one domain between two domains with non-overlapping users and items.

### Solution to Problem

The preference inference device according to the present invention including a preference inference means that infers, based on a conversion rule that approximates a first preference distribution for items in a first domain indicated by a first user set to a second preference distribution for items in a second domain indicated by a second user set, a preference in the second domain for a user in the first user set.

The preference inference method according to the present invention including causing a computer to infer, based on a conversion rule that approximates a first preference distribution for items in a first domain indicated by a first user set to a second preference distribution for items in a second domain indicated by a second user set, a preference in the second domain for a user in the first user set.

The preference inference program according to the present invention causes the computer to perform a preference inference processing of inferring, based on a conversion rule that approximates a first preference distribution for items in a first domain indicated by a first user set to a second preference distribution for items in a second domain indicated by a second user set, a preference in the second domain for a user in the first user set.

### Advantageous Effects of Invention

The invention allows for inferring preferences in the other domain regarding users in one domain between two domains with non-overlapping users and items.

### BRIEF DESCRIPTION OF DRAWINGS

FIG. 1 It depicts a block diagram showing an example configuration of a recommendation system according to the present invention.

FIG. 2 It depicts an explanatory diagram of an example of training data.

FIG. 3 It depicts an explanatory diagram of an example of a process of inferring the distribution of preferences.

FIG. 4 It depicts an explanatory diagram of an example of a process that performs a conversion to match the preference distributions.

FIG. 5 It depicts an explanatory diagram of an example of a process of learning a conversion rule.

FIG. 6 It depicts an explanatory diagram of an example of a process of suppressing mode collapse.

FIG. 7 It depicts an explanatory diagram of an example of a mapping.

FIG. 8 It depicts an explanatory diagram of an example of a process of aligning the axes of a preference dimension using a conversion rule.

FIG. 9 It depicts an explanatory diagram of an example of a process of inferring preferences.

FIG. 10 It depicts a flowchart showing an example of an operation of a learner.

FIG. 11 It depicts a flowchart showing an example of an operation of a preference inference device.

FIG. 12 It depicts a block diagram showing an overview of a preference inference device according to the present invention.

FIG. 13 It depicts a schematic block diagram showing a configuration of a computer for at least one example embodiment.

### DESCRIPTION OF EMBODIMENTS

Hereinafter, exemplary embodiments of the present invention will be described with reference to the drawings.

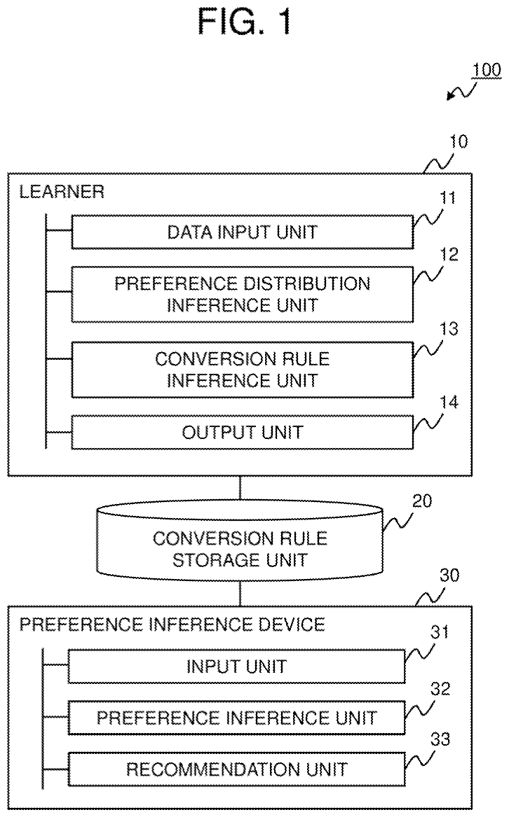

FIG. 1 is a block diagram showing an example configuration of an exemplary embodiment of a recommendation system. The recommendation system 100 of this exemplary embodiment includes a learner 10, a conversion rule storage unit 20, and a preference inference device 30.

In the example illustrated in FIG. 1, the conversion rule storage unit 20 is described separately from the learner 10 and the preference inference device 30, but the conversion rule storage unit 20 may be included in either or both of the learner 10 and the preference inference device 30.

The learner 10 includes a data input unit 11, a preference distribution inference unit 12, a conversion rule inference unit 13, and an output unit 14.

The data input unit 11 inputs training data to be used by the preference distribution inference unit 12 for the inference process described below. The data input unit 11 may read the training data from a storage device (not shown) included in the learner 10, or may accept input of training data from external storage via a communication line.

In this exemplary embodiment, information indicating user responses to items in each domain is used as training data. The information indicating user responses includes, for example, user browsing actual results and purchase actual results. The item means an item targeted in each domain, such as a product or service. In the following description, a product is exemplified as an item, but an item does not necessarily have to be an item to be purchased.

In addition, in this exemplary embodiment, it is assumed that a common user cannot be specified between the domains for the users of any two domains. This corresponds, for example, to a situation where user information cannot be shared between different industries. However, this assumption does not exclude situations where there are common users or where users can be identified. For example, it may be a situation where some common users can be identified between domains.

Furthermore, in this exemplary embodiment, even the personal information of the user (e.g., gender, age, hobbies, etc.) is unnecessary, and the training data may include information indicating which item in the domain each user responded to. However, this assumption does not exclude situations where user personal information is present, and personal information may be associated with each user.

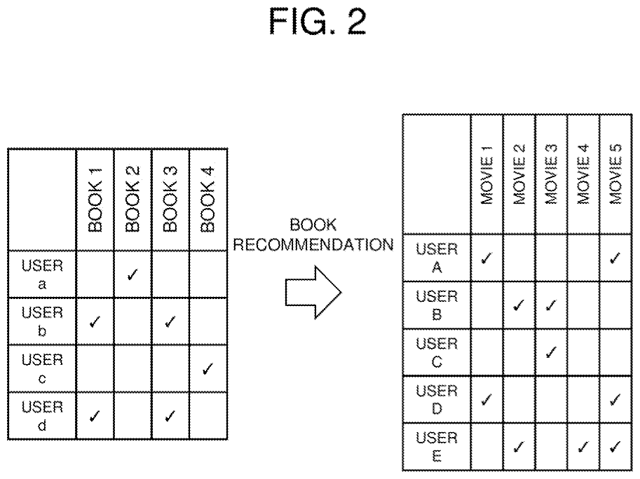

FIG. 2 is an explanatory diagram of an example of training data. The training data illustrated in FIG. 2 shows browsing actual results in two domains. It is assumed that domain 1 illustrated in FIG. 2 is the movie domain and domain 2 is the book domain. FIG. 2 shows the browsing actual results of users A to E for items (movies 1 to 5) in domain 1 and the browsing actual results of users a to d for items (books 1 to 4) in domain 2.

In the example illustrated in FIG. 2, the existence of actual results viewed by each user is indicated by a check, but information indicating user response is not limited to the existence of actual results, but may be, for example, the number of times an item is purchased or the evaluation value for an item.

The preference inference device 30, described below, also recommends items to users across domains. For example, in the example illustrated in FIG. 2, the preference inference device 30 performs a process of recommending books 1 to 4, which are items of domain 2, to users A to E of domain 1. The process of recommending is described below.

The preference distribution inference unit 12 infers, from the input training data, a distribution indicating user preferences (hereinafter referred to as “preference distribution”) for each domain. The method by which the preference distribution inference unit 12 infers the preference distribution is arbitrary. For example, the preference distribution inference unit 12 may infer the preference distribution of user using a recommendation model used in a recommendation system.

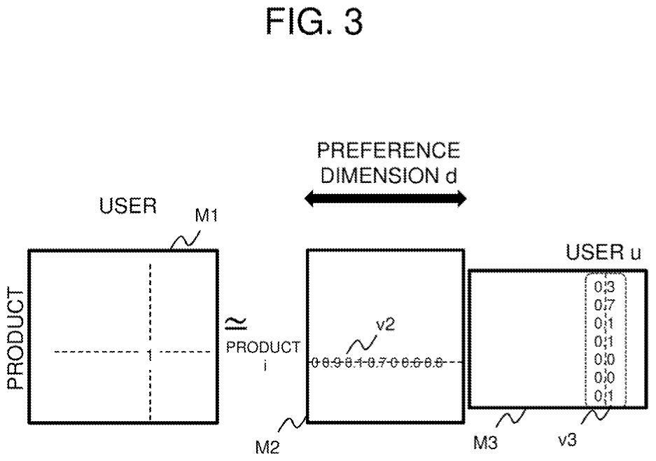

The following is an example of the process by which the preference distribution inference unit 12 infers the preference distribution. FIG. 3 is an explanatory diagram of an example of a process of inferring the distribution of preferences. It is assumed that the data input unit 11 accepts input of training data, for example, as illustrated in FIG. 2. The matrix indicating whether the user purchased the product or not, as illustrated in FIG. 2, is hereinafter referred to as a purchase matrix. The purchase matrix can also be referred to as a reaction matrix, since it is information indicating the user's reaction to the items in each domain.

The preference distribution inference unit 12 models the purchase matrix M1 as (attribute vector v2 of product i)×(preference vector v3 of user u) and performs matrix factorization to infer the matrix of product attributes (product attribute matrix M2) and the preferences matrix M3 of user.

Specifically, the preference distribution inference unit 12 may infer the product attribute matrix and the preference matrix to optimize Equation 1 exemplified below. In Equation 1, Yᵤᵢ indicates whether user u has purchased/not purchased product i in the purchase matrix M1 as 1/0. Also, q_{id} indicates the d-dimensional preference for product i in the product attribute matrix M2, and p_{ud} indicates the d-dimensional preference of user u in the preference matrix M3. This preference matrix corresponds to the preference distribution.

$$[ Math . 1 ]$$

$${arg min}_{{p}_{ud} \cdot {q}_{id}} {\sum }_{u , i} {( {Y}_{ui} - {\sum }_{d} {q}_{id} {p}_{ud} )}^{2} \qquad ( Equation 1 )$$

The conversion rule inference unit 13 infers conversion rules that approximate (match) the preference distributions of the two domains. Specifically, the conversion rule inference unit 13 infers the conversion rule that approximates the preference distribution (hereinafter referred to as a first preference distribution) or items in the first domain indicated by the first user set to the preference distribution (hereinafter referred to as a second preference distribution) for items in the second domain indicated by the second user set. Hereafter, the items in the first domain are sometimes referred to as first items and the items in the second domain are sometimes referred to as second items.

As mentioned above, it is not necessary to identify users in common between the first user set and the second use set in this exemplary embodiment.

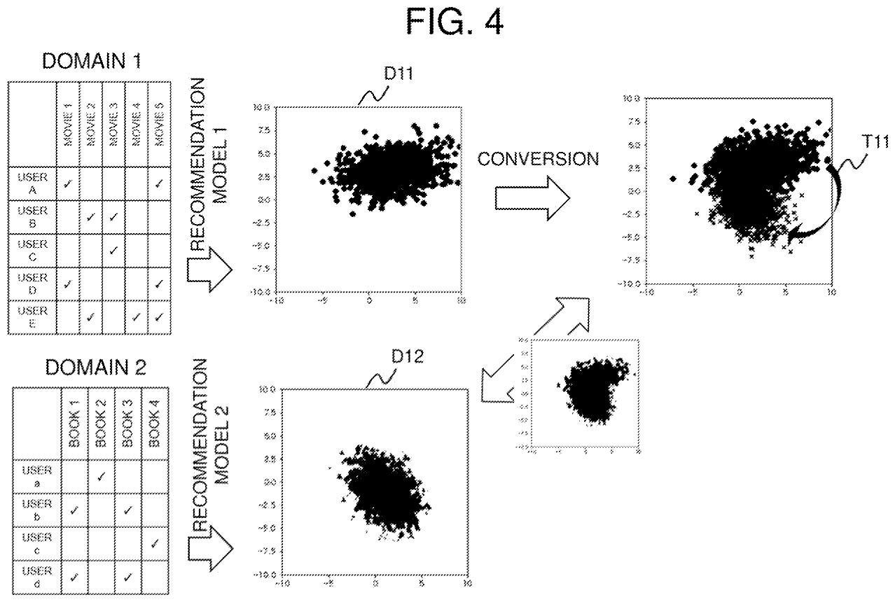

FIG. 4 is an explanatory diagram of an example of a process that performs a conversion to match the preference distributions. From the training data for domain 1 and domain 2 illustrated in FIG. 2, the first preference distribution D11 and the second preference distribution are generated. The entire first preference distribution thus generated is converted T11 so that it overlaps the second preference distribution. Specifically, as a result of performing the conversion T11 so that the preference distribution D11 indicated by the circles is superimposed on the preference distribution D12 indicated by the triangle marks, the preference distribution is converted into the preference distribution marked with a cross.

The method by which the conversion rule inference unit 13 infers the conversion rule is arbitrary, and the form of the inferred conversion rule is also arbitrary. Since the conversion rule specifies the process of converting the preference vectors, it can be called a projection (mapping). The dimensions of the preference vectors for each domain may be the same or different. In other words, the conversion rules may specify the process of converting to preference vectors of different dimensions. The conversion rule inference unit 13 may infer a conversion rule that simply rotates the first preference distribution to approximate the second preference distribution.

Otherwise, the conversion rule inference unit 13 identifies axes of each preference distribution by principal component analysis (PCA) and infers the conversion rule that makes the axes of the first preference distribution coincide with the axes of the second preference distribution.

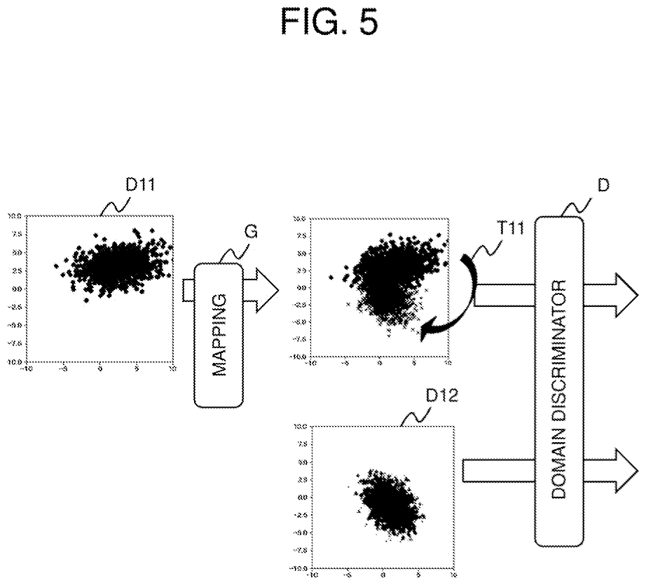

The conversion rule inference unit 13 may also infer the conversion rule for preference distributions by adversarial learning. The following is a specific example of inferring the conversion rules by adversarial learning. FIG. 5 is an explanatory diagram of an example of a process of learning the conversion rule.

The domain discriminator D illustrated in FIG. 5 is a discriminator that determines whether the sample is from the first or second domain. According to the conversion rule for converting the preference distribution of domain 1 (mapping G), the sample of domain 1 is converted to be the sample of domain 2, and the converted sample is discriminated by the domain discriminator D. The samples here correspond to the preference vectors of each domain.

The conversion rule inference unit 13 infers a conversion rule that converts the first preference distribution into the second preference distribution by learning so that the domain discriminator D can accurately guess which domain the samples are from, and by learning so that the samples converted by the mapping G are misclassified (deceived) by the domain discriminator D. The conversion rule inference unit 13 may, for example, infer the conversion rule by learning using Equation 2 illustrated below. In Equation 2, p₁(x) represents a sample of the preference distribution for domain 1, and p₂(x) represents a sample of the preference distribution for domain 2.

$$[ Math . 2 ]$$

$${min}_{G} {max}_{D} {𝔼}_{x \sim {p}_{2} ( x )} [ ln D ( x ) ] + {𝔼}_{x \sim {p}_{1} ( x )} [ ln ( 1 - D ( G ( x ) ) ] \qquad ( Equation 2 )$$

Note that a conversion rule that converts the first preference distribution into the second preference distribution may cause mode collapse with the above adversarial learning because of the high degree of freedom. For example, it is possible to deceive the domain discriminator D by performing a conversion that concentrates the mapping G to a single point in the distribution of domain 2. This is due to the result of a conversion that lacks the properties of the preference distribution of domain 1.

Therefore, the conversion rule inference unit 13 infers a conversion rule that approximates the first preference distribution to the second preference distribution, and also infers a conversion rule that approximates the second preference distribution to the first preference distribution (hereinafter referred to as an inverse conversion rule). The conversion rule inference unit 13 infers a conversion rule that approximates the second preference distribution to the first preference distribution. Then, the conversion rule inference unit 13 may infer the conversion rule so that the distribution converted by the inverse conversion rule to the result of converting the first preference distribution by the conversion rule approximates (returns to) the original first preference distribution.

Specifically, the conversion rule inference unit 13 may infer the conversion rule by adding a loss function (loss) to the objective function, where the loss is greater the more different the first preference distribution converted by the inverse conversion rule after being converted by the conversion rule is from the original first preference distribution. For example, the conversion rule may be inferred using the loss function (consistency loss) illustrated in Equation 3 below.

$$[ Math . 3 ]$$

$${L}_{consistency} = {\sum }_{u ∈ D 1} ‖ {G}^{′} ( G ( {x}_{u} ) ) - {x}_{u} ‖ \qquad ( Equation 3 )$$

In Equation 3, D1 denotes domain 1 and u denotes the (index of) user. Also, μ⋅μ denotes the norm between two vectors, for example, the L1 norm or the L2 norm.

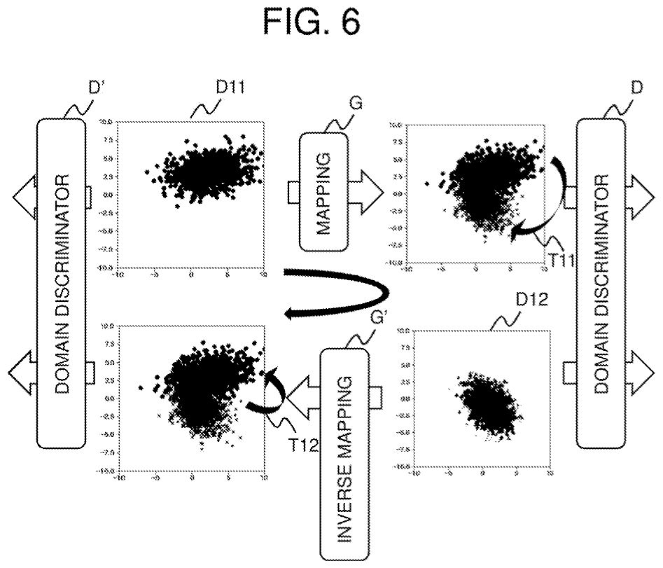

FIG. 6 is an explanatory diagram of an example of a process of suppressing mode collapse. The conversion rule inference unit 13 learns a mapping G that converts the preference distribution of domain 1 (first preference distribution) into the preference distribution of domain 2 and a domain discriminator D, and also learns an inverse mapping G′ that converts the preference distribution of domain 2 (second preference distribution) into the preference distribution of domain 1 and a domain discriminator D′. In doing so, the conversion rule inference unit 13 learns so that the result of the conversion T11 by the mapping G followed by the conversion T12 by the inverse mapping G′ approaches the original preference distribution. As a result, it is possible to suppress the conversion that lacks the property of the preference distribution of the domain 1, and thus it is possible to suppress the mode collapse.

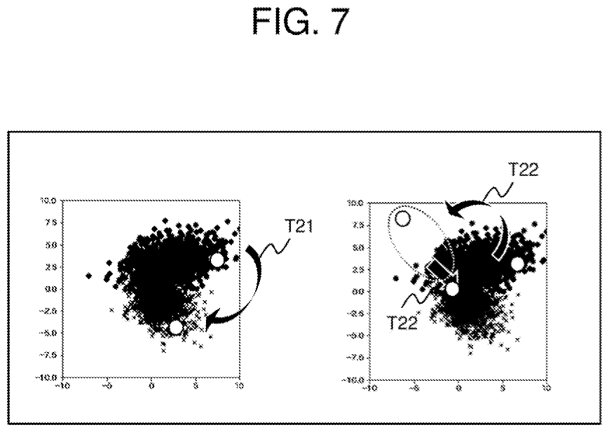

On the other hand, many solutions are assumed for the conversion rule (mapping). FIG. 7 is an explanatory diagram of an example of a mapping. The conversion T21 that rotates the distribution clockwise and the conversion T22 that rotates the distribution counterclockwise and then moves them in parallel approximately match the shape of the final distribution.

However, in situations where such mapping is allowed, the points indicating user preferences will be located at different points after mapping, which may lead to a decrease in accuracy and instability of results. Therefore, the conversion rule inference unit 13 may infer conversion rules based on constraints such that users with close properties are converted close together in the two domains. This means, for example, that in the example illustrated in FIG. 7, where the horizontal axis represents an axis indicating the degree of preference for a popular product, users who prefer popular products are placed closer together on the horizontal axis.

In this case, it is assumed that the user has a feature in common with the two domains (hereafter referred to as a common feature). The content of this common feature is arbitrary, and even if there are no specific common features, the conversion rule inference unit 13 may generate common features based on actual reactions (e.g., actual purchases). For example, a method to generate the common feature based on actual reactions includes, for example, calculating the reaction rate to popular products or new products.

Specifically, for each user v in domain 2, the conversion rule inference unit 13 learns model f which infers the common feature l₂ᵥ from the preference vector x₂ᵥ. The form of the model f is arbitrary. For example, the conversion rule inference unit 13 may learn to infer the matrix A and the bias b for a simple linear model represented by, for example, l₂ᵥ=A*x₂ᵥ+b.

Then, for each user u in domain 1, the conversion rule inference unit 13 establishes constraints such that for each user u in domain 1, the preference vector G (x₁ᵤ) obtained after mapping by the mapping G matches the common feature l₁ᵤ of each user u by the model f learned above. The conversion rule inference unit 13 may, for example, use the loss function illustrated in Equation 4 below as a constraint. By establishing such constraints, it is possible to learn a mapping such that users with close properties across domains are converted to close positions.

$$[ Math . 4 ]$$

$${L}_{semantic alignment} = {\sum }_{u ∈ D 1} ‖ f ( G ( {x}_{u} ) ) - {l}_{u} ‖ \qquad ( Equation 4 )$$

As shown above, it can be said that the conversion rule inference unit 13 learns the conversion rule for matching the preference distribution to obtain a mapping that aligns the axis of the preference dimension of domain 1 with the axis of the preference dimension of domain 2.

The output unit 14 outputs the inferred conversion rules. The output unit 14 may store the inferred conversion rules in the conversion rule storage unit 20.

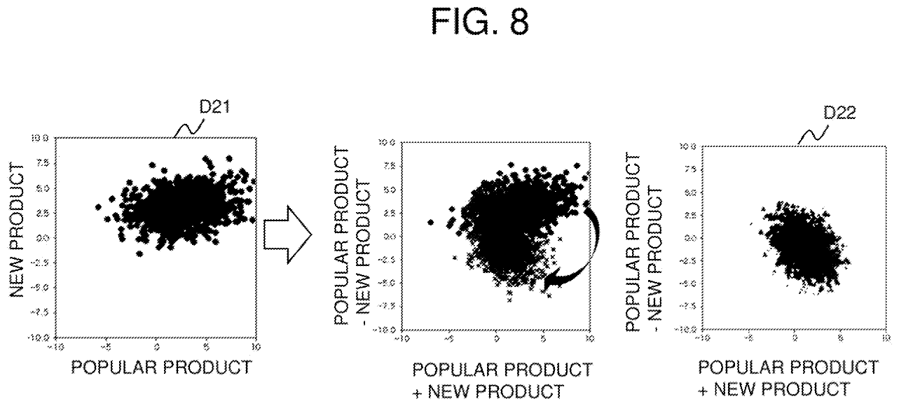

FIG. 8 is an explanatory diagram of an example of a process of aligning the axes of a preference dimension using a conversion rule. For example, it is assumed that, based on the matrix factorization shown above, it is inferred that there are two preference dimensions in domain 1, each containing preferences that are interpreted as “popular products” and “new products,” respectively. Then, it is assumed that when the vertical axis is “popular products” and the horizontal axis is “new products,” the preference distribution in domain 1 is the preference distribution D21 illustrated in FIG. 8. Similarly, it is assumed that it is inferred that there are two preference dimensions in domain 2, each containing preferences that are interpreted as “popular products+new products ” and “new products−new products,” respectively. Then, it is assumed that when the vertical axis is “popular products+new products ” and the horizontal axis is “popular products−new products,” the preference distribution in domain 2 is the preference distribution D22 illustrated in FIG. 8.

The inferred conversion rule (mapping) can be said to convert the axis of the preference dimension from “popular products” to “popular products+new products” and the axis of “new products” to “popular products−new products,” respectively. By performing such a conversion, the first preference distribution can be converted into the second preference distribution.

In other words, in this exemplary embodiment, the learner 10 uses the preference distributions shown by the user sets in the two domains that have already been learned and learns a mapping such that the preference distribution in one domain overlaps the preference distribution in the other domain. Therefore, it is possible to project the user's preference vector in one domain onto the preference vector in the other domain. In addition, in this exemplary embodiment, the conversion rule inference unit 13 infers conversion rules based on the preference vectors inferred from each user's actual data. Therefore, whereas the general method requires a cost equivalent to the number of actual data for learning, in this exemplary embodiment, the cost for learning is suppressed to the number of users.

The conversion rule storage unit 20 stores the inferred conversion rules. The conversion rule storage unit 20 is realized by, for example, a magnetic disk.

The preference inference device 30 includes an input unit 31, a preference inference unit 32, and a recommendation unit 33.

The input unit 31 accepts inputs of the conversion rule and the preference of user in the first user set. The preference of user specifically corresponds to the user's preference vectors obtained from the preference distribution in domain 1. In the following description, users with accepted preferences are sometimes referred to as users to be recommended. The input unit 31 may, for example, obtain the conversion rule from the conversion rule storage unit 20.

The preference inference unit 32 infers the preferences for the users in the first user set (i.e., the users to be recommended) for the second domain based on the conversion rule. Specifically, the preference inference unit 32 infers the second domain preferences of the target user by applying the conversion rule to the preference vector of the target user.

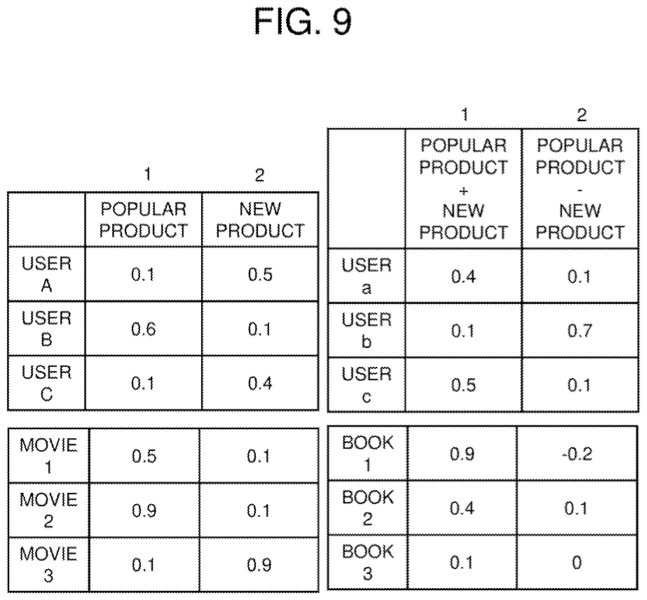

FIG. 9 is an explanatory diagram of an example of a process of inferring preferences. For example, as illustrated in FIG. 8, it is assumed that a preference in domain 1 is interpreted in the two dimensions of “popular products” and “new products,” and a preference in domain 2 is interpreted in the two dimensions of “popular products +new products ” and “popular products−new products”. In addition, it is assumed that the above matrix factorization has specifically obtained the attribute vectors of the products in each domain and the user's preference vectors, as illustrated in FIG. 9.

For example, in the example illustrated in FIG. 9, a user A's preference vector in domain 1 is (0.1, 0.5). By applying the conversion rule to this preference vector, a preference vector (0.6 (=0.1+0.5), −0.4 (=0.1−0.5)) in domain 2 for user A is obtained. The same is true for other users.

The recommendation unit 33 recommends a second item to the target user based on the inferred target user's (i.e., the user in the first user set) preference in the second domain. The item attribute vector is a vector indicating the attributes of the item corresponding to the user's preferences, and corresponds, for example, to the attribute vector of the product inferred by the matrix factorization described above.

Specifically, the recommendation unit 33 determines the second item to be recommended to the target user based on the item attribute vector of the second domain and the inferred preference vector of the target user. For example, the recommendation unit 33 may calculate the inner product of the item attribute vector of the second domain and the preference vector of the target user for recommendation, and recommend the item with the higher value calculated to the target user for recommendation.

For example, it is assumed that the preference vector in domain 2 for user A, illustrated in FIG. 9, is (0.6, −0.4). Additionally, the item attribute vector of book 1 in domain 2 is (0.9, −0.2). In this case, the recommendation unit 33 calculates an inner product of book 1 (0.6×0.9+(−0.4)×(−0.2)=0.62), which is the recommendation value for book 1. Similarly, the recommendation value of book 2 is calculated to be 0.20, and the recommendation value of book 3 is calculated to be 0.06. The recommendation unit 33 may, for example, recommend book 1 with the highest recommendation value to user A.

The data input unit 11, the preference distribution inference unit 12, the conversion rule inference unit 13, and the output unit 14 are realized by a computer processor (for example, a CPU (Central Processing Unit), or a GPU (Graphics Processing Unit)) of a computer operating according to a program (learning program). The input unit 31, the preference inference unit 32, and the recommendation unit 33 are also realized by a computer processor of a computer operating according to a program (preference inference program).

For example, the learning program may be stored in a storage unit (not shown), which is a program storage unit provided by the learner 10, and the processor may read the program to operate as the data input unit 11, preference distribution inference unit 12, conversion rule inference unit 13, and output unit 14 according to the program. Further, the functions of the learner 10 may be provided in the form of SaaS (Software as a Service).

Similarly, the preference inference program may be stored in a storage unit (not shown), which is a program storage unit provided by the preference inference device 30, and the processor may read the program to operate as input unit 31, the preference inference unit 32, and the recommendation unit 33 according to the program. Further, the preference inference device 30 may be provided in the form of SaaS (Software as a Service).

In addition, the data input unit 11, the preference distribution inference unit 12, the conversion rule inference unit 13, and the output unit 14, as well as input unit 31, preference inference unit 32, and recommendation unit 33, may also be implemented by dedicated hardware, respectively. Further, a part or the whole of each of components of each device may be implemented by a general-purpose or dedicated circuit (circuitry), a processor, or a combination thereof. These components may be configured by a single chip or by plural chips connected through a bus. A part or the whole of each of components of each device may also be implemented by a combination of the above-described circuit or the like and the program.

When a part or the whole of each of components of the learner 10 and the preference inference device 30 is implemented by a plurality of information processing devices or circuits, the plurality of information processing devices or circuits may be centrally arranged, or arranged in a distributed manner. For example, the plurality of information processing devices or circuits may be realized in the form of being connected through a communication network such as a client server system and a cloud computing system.

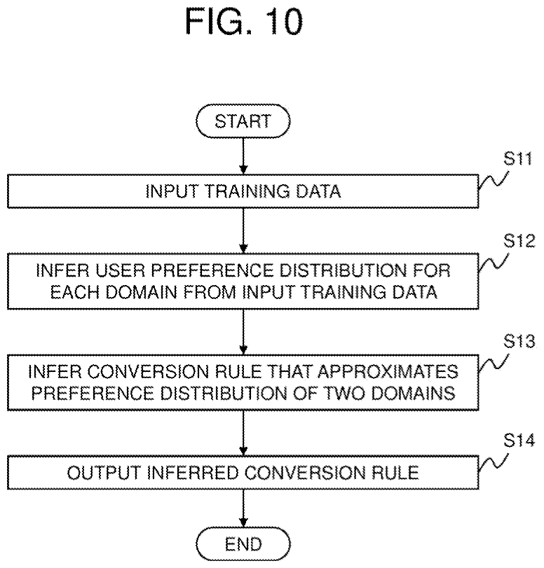

Next, the operation of the recommendation system 100 of the exemplary embodiment will be described. FIG. 10 is a flowchart showing an example of an operation of the learner 10. The data input unit 11 inputs training data (step S11). The preference distribution inference unit 12 infers the user preference distribution for each domain from the input training data (step S12). The conversion rule inference unit 13 infers a conversion rule that approximates the preference distributions of the two domains (step S13). The output unit 14 outputs the inferred conversion rule (step S14).

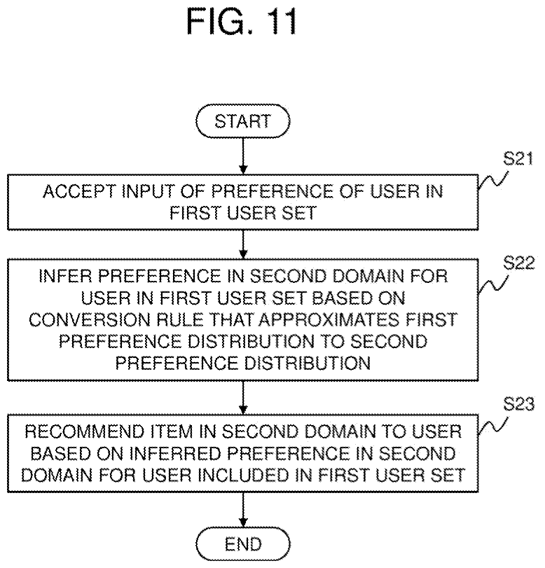

FIG. 11 is a flowchart showing an example of an operation of the preference inference device 30. The input unit 31 accepts input of a preference (preference vector) of a user in a first user set (step S21). The preference inference unit 32 infers the preferences in the second domain for the user in the first user set based on a conversion rule that approximates a first preference distribution to a second preference distribution (step S22). Specifically, the preference inference unit 32 applies the conversion rule to the preference vector of a user included in the first user set to infer the preference in the second domain for that user. Then, the recommendation unit 33 recommends an item in the second domain to that user based on the inferred preferences in the second domain for the user included in the first user set (step S23).

As described above, in this exemplary embodiment, the preference inference unit 32 infers a preference in the second domain for a user in a first user set based on a conversion rule that approximates a first preference distribution to a second preference distribution. Thus, it is possible to infer preferences in the other domain regarding users in one domain between two domains with non-overlapping users and items. This allows, for example, to recommend more appropriate music to a user who is active on a movie review site.

In this exemplary embodiment, the conversion rule inference unit 13 uses the preference distributions of the user sets of the two domains learned by the preference distribution inference unit 12 to learn an appropriate mapping such that the preference distribution of one domain overlaps the other. Thus, it is possible to project the user's preference vector in one domain onto the preference vector in the other domain.

An example of utilization of this exemplary embodiment is the transfer of customers between a plurality of services. For example, recommending a product from a social networking service (SNS) to another service, or recommending a product in a different category to an active user in a specific category. Other examples include sending customers between stores at department stores and shopping malls, guiding users of one brand to another brand, and mutually recommending products using data held by multiple companies.

For example, as a specific situation, it is assumed that there is a user's review data on a social networking site for a certain movie and another user's review data on a different music streaming service site, and it is assumed to recommend appropriate music to the movie reviewers. In such a case, it is usually the case that the same user cannot be identified between the two domains due to a combination of personal information protection and contracts between the companies. In addition, common products are usually not handled.

In the method as described in Non-Patent Literature 1, transactions from each domain are used to train a common model. Therefore, learning costs are incurred for the number of transactions. In addition, it lacks flexibility because transaction data is often not available, such as data between companies.

On the other hand, in this exemplary embodiment, since the processing for matching the user distribution (preference distribution) obtained from the existing recommendation system or the like is performed, learning can be performed at the cost of the order of the number of users.

For example, if there are 10 to 100 transactions for a single user, compared to general learning methods, in this exemplary embodiment, it is possible to realize a speed increase of 10 to 100 times. Furthermore, since preference distributions can be generated at independent times, it is possible to construct a flexible system.

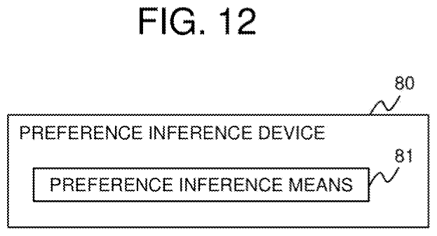

The following is an overview of the invention. FIG. 12 is a block diagram showing an overview of a preference inference device according to the present invention. The preference inference device 80 (e.g., preference inference device 30) according to the present invention includes a preference inference means 81 (e.g., preference inference unit 32) that infers, based on a conversion rule that approximates a first preference distribution for items in a first domain indicated by a first user set to a second preference distribution for items in a second domain indicated by a second user set, a preference in the second domain for a user in the first user set.

Such a configuration allows for inferring preferences in the other domain regarding users in one domain between two domains with non-overlapping users and items.

Specifically, the preference inference means 81 may apply a conversion rule to a preference vector of a user in the first user set to infer a preference in the second domain of the user.

The preference inference device 80 may also include a recommendation means (e.g., recommendation unit 33) that recommends an item in the second domain to the user based on the inferred preferences in the second domain for the user included in the first user set.

Specifically, the preference inference means may determine the second item to recommend to the user based on an attribute of the item in the second domain (e.g., the item attribute vector) and the inferred preferences in the second domain for the user in the first user set (e.g., the preference vector).

The preference distribution may be derived (e.g., by the preference distribution inference unit 12) from a preference matrix obtained by performing a matrix factorization of a reaction matrix showing the user's reaction to an item in each domain into an attribute matrix representing an attribute of an item and the preference matrix representing the user's preference.

The conversion rule may be learned (e.g., by the conversion rule inference unit 13) by adversarial learning to cause a discriminator (e.g., domain discriminator D) to misclassify a sample in the first domain converted by the conversion rule as a sample in the second domain, along with learning the discriminator to discriminate between a sample in the first domain and a sample in the second domain.

Furthermore, the conversion rule may be learned (e.g., by the conversion rule inference unit 13) together with an inverse conversion rule (e.g., inverse mapping G′) that approximates the second preference distribution to the first preference distribution so that the result of converting a sample of the first domain converted by the conversion rule with the inverse conversion rule approximates the original sample. By using such a conversion rule, mode collapse can be suppressed.

In addition, the conversion rule may be learned (e.g., by the conversion rule inference unit 13) based on constraints such that a user with close property is converted close in the two domains.

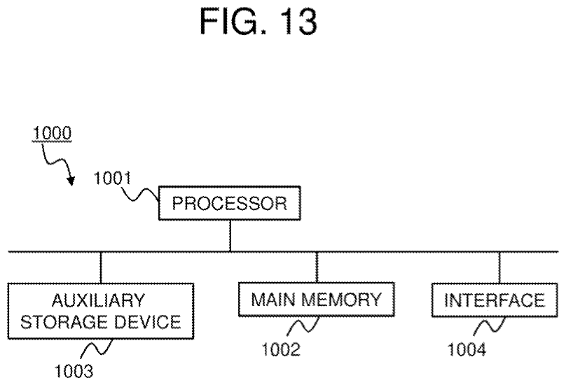

FIG. 13 is a schematic block diagram showing a configuration of a computer for at least one example embodiment. A computer 1000 includes a processor 1001, a main memory 1002, an auxiliary memory 1003, and an interface 1004.

The above-described preference inference device 80 is implemented on the computer 1000. Then, the operation of each of the above-described processing units is stored in the auxiliary storage device 1003 in the form of a program (learning program). The processor 1001 reads the program from the auxiliary storage device 1003 and develops the program to the main storage device 1002 to execute the above processing according to the program.

In at least one exemplary embodiment, the auxiliary storage device 1003 is an example of a non-transitory tangible medium. The other examples of the non-transitory tangible medium include a magnetic disk, a magneto-optical disk, a CD-ROM (Compact Disc Read-only memory), a DVD-ROM (Read-only memory), and a semiconductor memory connected through the interface 1004. Further, when this program is distributed to the computer 1000 through a communication line, the computer 1000 may develop the distributed program to the main storage device 1002 to execute the above processing.

Further the program may be to implement some of the functions described above. Further, the program may be a so-called differential file (differential program) which implements the above-described functions in combination with another program already stored in the auxiliary storage device 1003.

Some or all of the above exemplary embodiments may also be described as, but not limited to the following.

(Supplementary note 1) A preference inference device comprising a preference inference means that infers, based on a conversion rule that approximates a first preference distribution for items in a first domain indicated by a first user set to a second preference distribution for items in a second domain indicated by a second user set, a preference in the second domain for a user in the first user set.

(Supplementary note 2) The preference inference device according to Supplementary note 1, wherein the preference inference means applies a conversion rule to a preference vector of a user in the first user set to infer a preference in the second domain of the user.

(Supplementary note 3) The preference inference device according to Supplementary note 1 or 2, further comprising: a recommendation means that recommends an item in the second domain to the user based on the inferred preferences in the second domain for the user included in the first user set.

(Supplementary note 4) The preference inference device according to Supplementary note 3, wherein the preference inference means determines the second item to recommend to the user based on an attribute of the item in the second domain and the inferred preferences in the second domain for the user in the first user set.

(Supplementary note 5) The preference inference device according to any one of Supplementary notes 1 to 4, wherein the preference distribution is derived from a preference matrix obtained by performing a matrix factorization of a reaction matrix showing the user's reaction to an item in each domain into an attribute matrix representing an attribute of an item and the preference matrix representing the user's preference.

(Supplementary note 6) The preference inference device according to any one of Supplementary notes 1 to 5, wherein the conversion rule is learned by adversarial learning to cause a discriminator to misclassify a sample in the first domain converted by the conversion rule as a sample in the second domain, along with learning the discriminator to discriminate between a sample in the first domain and a sample in the second domain.

(Supplementary note 7) The preference inference device according to Supplementary note 6, wherein the conversion rule is learned together with an inverse conversion rule that approximates the second preference distribution to the first preference distribution so that the result of converting a sample of the first domain converted by the conversion rule with the inverse conversion rule approximates the original sample.

(Supplementary note 8) The preference inference device according to Supplementary note 6 or 7, wherein the conversion rule is learned based on constraints such that a user with close property is converted close in the two domains.

(Supplementary note 9) A preference inference method comprising causing a computer to infer, based on a conversion rule that approximates a first preference distribution for items in a first domain indicated by a first user set to a second preference distribution for items in a second domain indicated by a second user set, a preference in the second domain for a user in the first user set.

(Supplementary note 10) A preference inference method according to Supplementary note 9, comprising causing a computer to apply a conversion rule to a preference vector of a user in the first user set to infer a preference in the second domain of the user.

(Supplementary note 11) A program storage medium storing a preference inference program causing a computer to perform a preference inference processing of inferring, based on a conversion rule that approximates a first preference distribution for items in a first domain indicated by a first user set to a second preference distribution for items in a second domain indicated by a second user set, a preference in the second domain for a user in the first user set.

(Supplementary note 12) The program storage medium storing the preference inference program according to Supplementary note 11, wherein a conversion rule is applied to a preference vector of a user in the first user set to infer a preference in the second domain of the user, in the preference inference processing.

Although the invention has been described above with reference to exemplary embodiments and examples, the invention is not limited to the above exemplary embodiments and examples. Various changes can be made in the composition and details of the present invention that can be understood by those skilled in the art within the scope of the present invention.

### REFERENCE SIGNS LIST

10 Learner
11 Data input unit
12 Preference distribution inference unit
13 Conversion rule inference unit
14 Output unit
20 Conversion rule storage unit
30 Preference inference device
31 Input unit
32 Preference inference unit
33 Recommendation unit
100 Recommendation system

What is claimed is:

1. A preference inference device comprising:
a memory storing instructions; and
one or more processors configured to execute the instructions to infer a preference, based on a conversion rule, the rule approximating a first preference distribution for items in a first domain indicated by a first user set to a second preference distribution for items in a second domain indicated by a second user set, the preference in the second domain for a user in the first user set.

2. The preference inference device according to claim 1, wherein the processor is configured to execute the instructions to
apply a conversion rule to a preference vector of a target user in the first user set to infer a preference in the second domain of the target user.

3. The preference inference device according to claim 1, wherein the processor is configured to execute the instructions to
recommend an item in the second domain to the target user based on the inferred preferences in the second domain for the target user included in the first user set.

4. The preference inference device according to claim 3, wherein the processor is configured to execute the instructions to
determine the second item to recommend to the target user based on an attribute of the item in the second domain and the inferred preferences in the second domain for the target user in the first user set.

5. The preference inference device according to claim 1, wherein
the preference distribution is derived from a preference matrix obtained by performing a matrix factorization of a reaction matrix showing the user's reaction to an item in each domain into an attribute matrix representing an attribute of an item and the preference matrix representing the user's preference.

6. The preference inference device according to claim 1, wherein
the conversion rule is learned by adversarial learning to cause a discriminator to misclassify a sample in the first domain converted by the conversion rule as a sample in the second domain, along with learning the discriminator to discriminate between a sample in the first domain and a sample in the second domain.

7. The preference inference device according to claim 6, wherein
the conversion rule is learned together with an inverse conversion rule that approximates the second preference distribution to the first preference distribution so that the result of converting a sample of the first domain converted by the conversion rule with the inverse conversion rule approximates the original sample.

8. The preference inference device according to claim 6, wherein
the conversion rule is learned based on constraints such that a user with close property is converted close in the two domains.

9. A preference inference method comprising
causing a computer to infer a preference, based on a conversion rule, the rule approximating a first preference distribution for items in a first domain indicated by a first user set to a second preference distribution for items in a second domain indicated by a second user set, the preference in the second domain for a user in the first user set.

10. A preference inference method according to claim 9, comprising
causing a computer to apply a conversion rule to a preference vector of a target user in the first user set to infer a preference in the second domain of the target user.

11. A non-transitory computer readable information recording medium storing a preference inference program, when executed by a processor, that performs a method for
inferring a preference, based on a conversion rule, the rule approximating a first preference distribution for items in a first domain indicated by a first user set to a second preference distribution for items in a second domain indicated by a second user set, the preference in the second domain for a user in the first user set.

12. The non-transitory computer readable information recording medium storing according to claim 11, wherein
a conversion rule is applied to a preference vector of a target user in the first user set to infer a preference in the second domain of the target user, in the preference inference processing.
